(19) United States
(12) Patent Application Publication
(10) Pub. No.: US 2017/0089375 A1
(43) Pub. Date: Mar. 30, 2017

(54) Telescoping Pipe Fitting

(71) Applicants: Zhongshan PinChuang Plastic Products Co., Ltd., Zhongshan City (CN); Shenzhen Plentiful Technology Co., Ltd., Shenzhen (CN)

(72) Inventor: Tao Liu, Zhongshan City (CN)

(21) Appl. No.: 15/175,321

(22) Filed: Jun. 7, 2016

(30) Foreign Application Priority Data
Sep. 25, 2015 (CN) 201520759892.3

(51) Int. Cl. F16B 7/14

(52) U.S. Cl. CPC F16B 7/1481

(57) ABSTRACT

A telescoping pipe fitting has a telescoping pipe body with an inner pipe and an outer pipe movably sleeved outside the inner pipe. One end of the inner pipe is at least provided with two non-slip sheets. An elastic member configured to extrude the non-slip sheets to stretch outwards and cling to the inner wall of the outer pipe is positioned between the non-slip sheets. The length of the telescoping pipe fitting can be changed only when a user applies an external force that overcomes the frictional force between the inner pipe and the outer pipe. When the external force is withdrawn, the entire length of the telescoping pipe fitting is fixed and unchanged.

### TECHNICAL FIELD

The disclosure relates to a photographic apparatus, and more particularly, to a telescoping pipe fitting applied to a tripod and a selfie stick.

### BACKGROUND

Presently, most telescoping pipe fittings applied to the photographic field are composed of an outer pipe having a large diameter and an inner pipe having a small diameter that are sleeved mutually to each other, and then the outer pipe and the inner pipe are locked tightly using a buckle or the diameter difference between the outer pipe and the inner pipe. However, this structure is not beneficial for the production and assembly of the telescoping pipe fitting, and has high production cost, and the quantity or length of the pipe cannot be adjusted according to the using requirements.

Chinese utility model CN2 (04061447U) discloses an eccentric pipe structure, which includes two eccentric pipe bodies with matched diameter, and a slip sheet is installed at one end of the pipe body having a relatively smaller diameter at the junction of every two pipe bodies. The utility model can provide an eccentric pipe structure which is convenient to telescope, is portable and light, is convenient to assemble, has low production cost, and can adjust the quantity or length of the pipe according to the using requirements. However, the device disclosed therein mainly has the following disadvantages: the production process of the eccentric pipe body is complicated, the precision is difficult to control, and the universality of the production equipment and products is low.

China utility model CN2 (03257825U) discloses a novel successive telescoping device for tripods, including a big telescoping pipe and a small telescoping pipe which are connected to each other in a telescoping manner, and both the big telescoping pipe and the small telescoping pipe are circular pipes, and a rotary locking mechanism is arranged between the big telescoping pipe and the small telescoping pipe. The utility model effectively increases the locking area between the big telescoping pipe and the small telescoping pipe, has good locking effect, is stable in performances, is guaranteed, and is simple, easy and quick to operate, has simple structure, is durable, is beautiful in appearance, and is more flexible and convenient to produce and process. However, the device disclosed therein mainly has the following disadvantages: although the device employs circular pipes, the locking structure thereof is still relatively complicated.

### SUMMARY

In order to solve the foregoing problems, the disclosure provides a telescoping pipe fitting which is simple in structure, and is convenient to produce and process; moreover, not only the entire length of the telescoping pipe fitting can be adjusted randomly, but also the entire length thereof can be locked.

To solve the technical problem, the disclosed pipe fitting employs the technical solutions as follows.

A telescoping pipe fitting includes a telescoping pipe body, wherein the telescoping pipe body is composed of an inner pipe and an outer pipe movably sleeved outside the inner pipe, one end of the inner pipe is at least provided with two non-slip sheets which can separate from each other, and an elastic member configured to extrude the non-slip sheets to stretch outwards and cling to the inner wall of the outer pipe is arranged between the non-slip sheets.

As an improvement of the foregoing technical solution, the non-slip sheet is a circular sheet that can be jointed to the outside of the inner pipe.

As a further improvement of the foregoing technical solution, the outer wall of the inner pipe is provided with locating holes for locating and installing the non-slip sheets, and the side walls of the non-slip sheets toward the inner pipe are provided with protrusions that can be embedded into the locating holes.

Preferably, the elastic member is an elastic ring with a notch.

In the disclosed device, one end of the inner pipe is provided with two non-slip sheets, and the inner walls of the two non-slip sheets are provided with recesses for placing the elastic member.

As a preferred embodiment of the disclosed pipe fitting, the elastic member is a compression spring, and the two ends of the compression spring are respectively butted with the inner walls of the two non-slip sheets.

The disclosed device affords the advantageous effects in that: because the pipe fitting is at least provided with two non-slip sheets at one end of the inner pipe, and the elastic member configured to extrude the non-slip sheets to stretch outwards and cling to the inner wall of the outer pipe is arranged between the non-slip sheets, the frictional force between the inner pipe and the outer pipe is greatly increased by cling the non-slip sheets to the inner wall of the outer pipe, so that relative motion cannot easily occur between the inner pipe and the outer pipe; therefore, when the user adjusts the length of the disclosed telescoping pipe fitting, the telescoping pipe fitting can be stretched or retracted randomly by applying an external force that overcomes the frictional force between the inner pipe and the outer pipe; the operation is simple and quick; when the user removes the external force that overcomes the frictional force between the inner pipe and the outer pipe, the frictional force between the inner pipe and the outer pipe enables the inner pipe and the outer pipe to keep the current status and not move relatively, so that the entire length of the disclosed telescoping pipe fitting remains unchanged.

Through the above structure, the length of the telescoping pipe fitting of the utility model can be changed only when a user applies an external force that overcomes the frictional force between the inner pipe and the outer pipe; when the external force is withdrawn, the entire length of the telescoping pipe fitting is fixed and unchanged; the telescoping pipe fitting is simple, convenient and quick to operate; moreover, the above parts can be manufactured independently, have lower requirements for precision, are convenient to produce and manufacture, and are beneficial for improving the production efficiency of the disclosed telescoping pipe fitting.

### BRIEF DESCRIPTION OF THE DRAWINGS

The disclosed embodiments are further described in detail hereunder with reference to the drawings, where like numerals reflect like elements:

FIG. 1 is schematic diagram showing an external structure of a preferred embodiment of the disclosed pipe fitting;

FIG. 2 is a schematic diagram showing an internal structure of a preferred embodiment of the disclosed pipe fitting in an extended state;

FIG. 3 is a schematic diagram showing a state when non-slip sheets in a preferred embodiment of the disclosed pipe fitting stretch out of an outer pipe;

FIG. 4 is a structural decomposition schematic diagram when non-slip sheets in a preferred embodiment of the disclosed pipe fitting stretch out of an outer pipe;

FIG. 5 is a part drawing of non-slip sheets in a preferred embodiment of the disclosed pipe fitting; and

FIG. 6 is an amplified schematic diagram of section A in FIG. 2.

### DETAILED DESCRIPTION

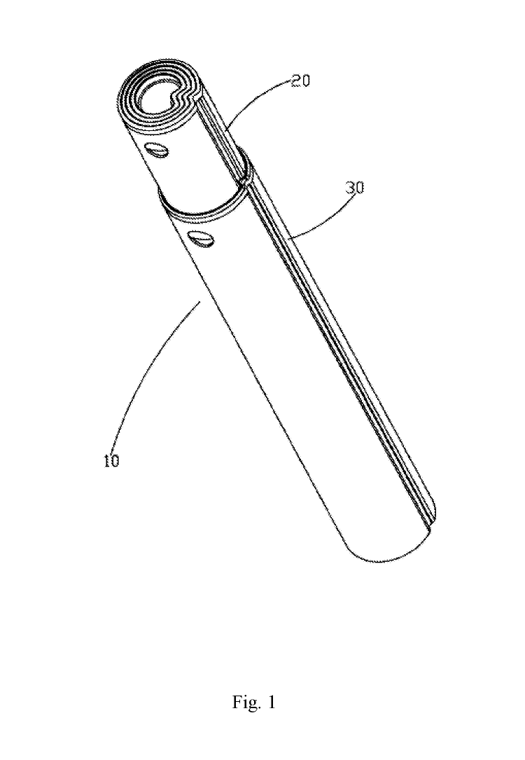

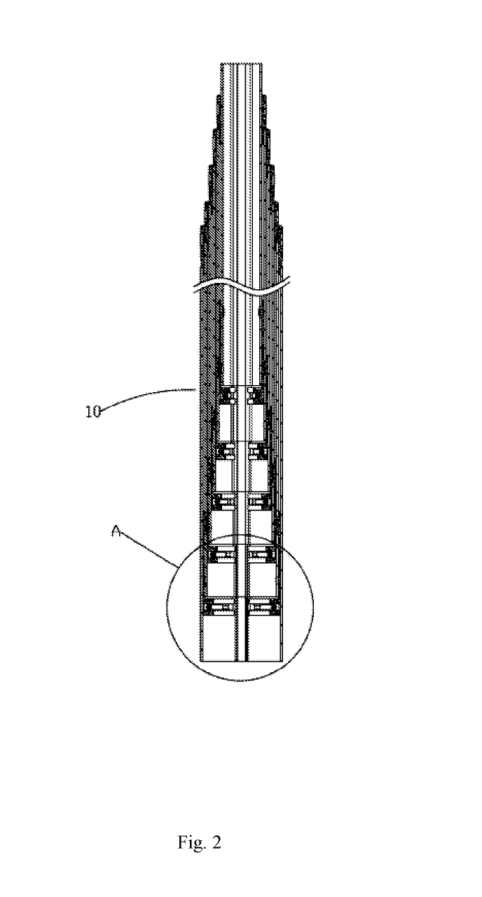

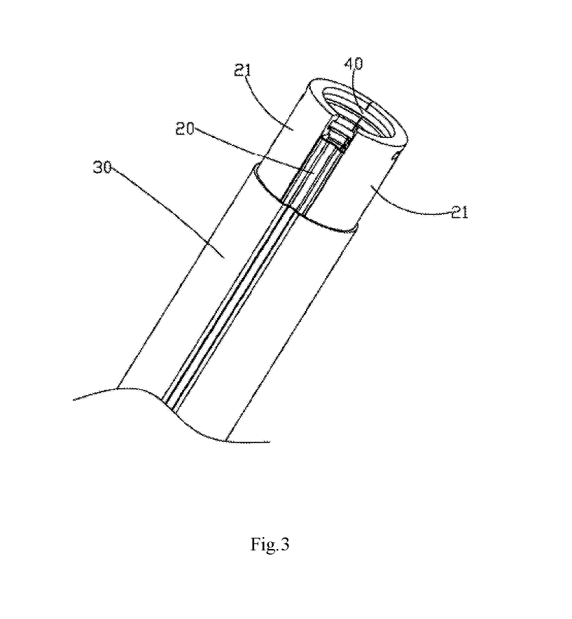

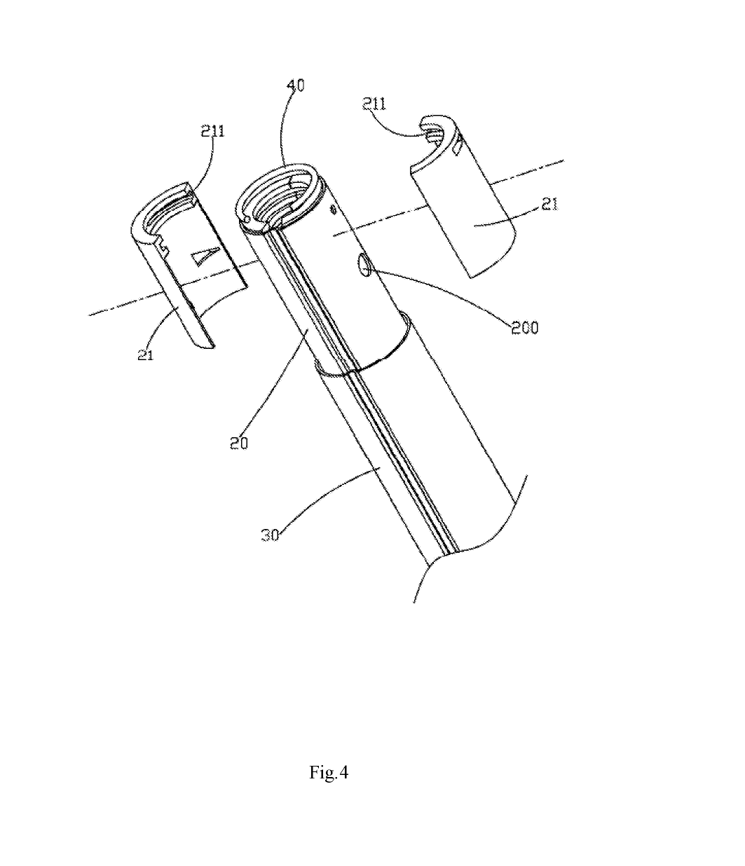

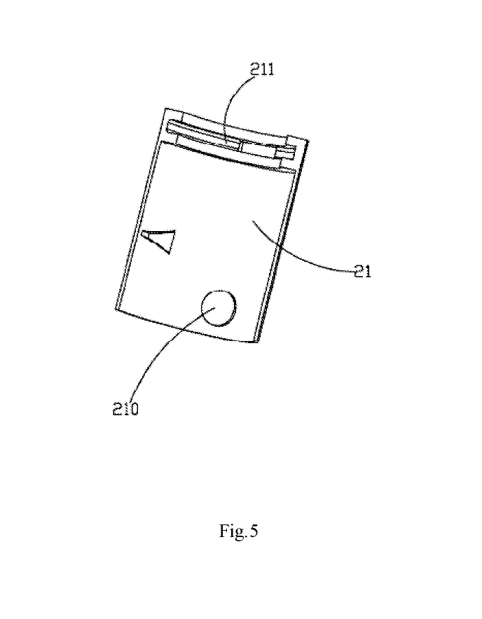

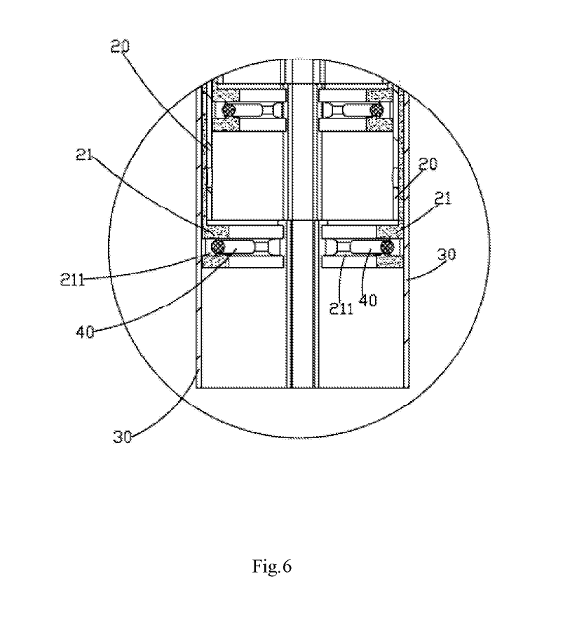

Referring to FIG. 1 through FIG. 6, a telescoping pipe fitting includes a telescoping pipe body 10, wherein the telescoping pipe body 10 is composed of an inner pipe 20 and an outer pipe 30 movably sleeved outside the inner pipe. As shown, the inner pipe 20 and the outer pipe 30 are two pipe fittings that are sleeved mutually to each other; the pipe fitting located externally is the outer pipe 30 while the pipe fitting located internally is the inner pipe 20. The telescoping pipe body 10 here may either be composed of two pipe fittings that are sleeved mutually to each other, or be composed of a plurality of pipe fittings that are sleeved mutually to each other. To be specific, the quantity of the pipe fittings that are sleeved mutually to each other can be freely selected according to the actual requirements. One end of the inner pipe 20 is at least provided with two non-slip sheets 21 which can separate from each other, and an elastic member 40 configured to extrude the non-slip sheets 21 to stretch outwards and cling to the inner wall of the outer pipe 30 is arranged between the non-slip sheets 21.

Because the device is at least provided with two non-slip sheets 21 at one end of the inner pipe 20, and the elastic member 40 configured to extrude the non-slip sheets 21 to stretch outwards and cling to the inner wall of the outer pipe 30 is arranged between the non-slip sheets 21, the frictional force between the inner pipe 20 and the outer pipe 30 is greatly increased by cling the non-slip sheets 21 to the inner wall of the outer pipe 30, so that relative motion cannot easily occur between the inner pipe 20 and the outer pipe 30. Therefore, when the user adjusts the length of the telescoping pipe fitting, the telescoping pipe fitting can be stretched or retracted randomly by applying an external force that overcomes the frictional force between the inner pipe 20 and the outer pipe 30; the operation is simple and quick. When the user removes the external force that overcomes the frictional force between the inner pipe 20 and the outer pipe 30, the frictional force between the inner pipe 20 and the outer pipe 30 enables the inner pipe 20 and the outer pipe 30 to keep the current status and not move relatively, so that the entire length of the telescoping pipe fitting of keeps unchanged. Through the above structure and relationships, the length of the disclosed telescoping pipe fitting can be changed only when a user applies an external force that overcomes the frictional force between the inner pipe 20 and the outer pipe 30. When the external force is withdrawn, the entire length of the telescoping pipe fitting is fixed and unchanged; the telescoping pipe fitting is simple, convenient and quick to operate. Moreover, the above parts can be manufactured independently, have lower requirements for precision, are convenient to produce and manufacture, and are beneficial for improving the production efficiency of the telescoping pipe fitting.

In order to conveniently arrange the non-slip sheets 21 at one end of the inner pipe 20, and in order to increase the contact area between the non-slip sheets 21 and the inner wall of the outer pipe 30, so as to increase the frictional force between the inner pipe 20 and the outer pipe 30 at the same time, the non-slip sheet 21 is a circular sheet that can be jointed to the outside of the inner pipe 20 preferably. Because the inner pipe 20 and the outer pipe 30 are two pipe fittings with approximate or identical section shapes, when the internal side of the non-slip sheet 21 can be jointed to the inner pipe 20, the external side of the non-slip sheet 21 can be substantially jointed to the interior of the outer pipe 30 entirely, thus increasing the contact area between the non-slip sheets 21 and the inner wall of the outer pipe 30. Here, in order to make the non-slip sheets 21 be better located and arranged on the inner pipe 20 and make the inner pipe 20 and the non-slip sheets 21 not to move relatively along the axial direction of the inner pipe 20, the outer wall of the inner pipe 20 is further preferably provided with locating holes 200 for locating and installing the non-slip sheets 21, and the side walls of the non-slip sheets 21 towards the inner pipe 20 are provided with protrusions 210 that can be embedded into the locating holes 200. Here, the above locating holes 200 may either be through holes or blind holes. The above non-slip sheets 21 may also be installed on the inner pipe 20 using other manners excluding being movably inserted in the outside of one end of the inner pipe 20 through the protrusions 210, for example, the non-slip sheet 21 is provided with a sunken hole, a connecting bolt fixedly connected to the inner pipe 20 is movably penetrated and installed in the sunken hole, and the non-slip sheet 21 can move outwards along the connecting bolt and cling to the interior of the outer pipe 30.

In order to facilitate the production and assembly of the telescoping pipe fitting, the elastic member 40 is an elastic ring with a notch preferably. Further preferably, one end of the inner pipe 20 is provided with two non-slip sheets 21, and recesses 211 for placing the elastic member 40 are arranged on the inner walls of the two non-slip sheets 21. When the elastic member 40 is placed between the two non-slip sheets 21, the elastic member 40 stretches outwards so as to extrude the two non-slip sheets 21 to stretch outwards and cling to the inner wall of the outer pipe 30, so that the frictional force between the inner pipe 20 and the outer pipe 30 is greatly increased. The quantity of the foregoing non-slip sheets 21 is preferably two, but is not limited to two, and may also be more, for instance, three, four, six, or the like. However, with the increasing of the quantity of the non-slip sheets 21, the production, processing and assembly of the disclosed telescoping pipe fitting may become more complicated.

Certainly, the above elastic member 40 may also be other part, for instance, the elastic member 40 is a compression spring, the two ends of the compression spring are respectively butted with the inner walls of the two non-slip sheets 21, and the two ends of the compression spring can similarly extrude the two non-slip sheets 21 to stretch outwards and cling to the inner wall of the outer pipe 30. Here, the quantity of the non-slip sheets 21 is not limited to two, and may also be other number, for instance, four. Two crosswise compression springs are needed to push against a pair of non-slip sheets 20 respectively.

The above descriptions are only preferred embodiments of the disclosed telescoping pipe fitting, and any technical solution implementing the object of the disclosure via a substantially identical means shall fall within the protection scope.

1. A telescoping pipe fitting, comprising a telescoping pipe body (10) having an inner pipe (20) and an outer pipe (30) movably sleeved outside the inner pipe (20);
two non-slip sheets (21) are positioned on one end of the inner pipe (20); and
an elastic member (40) positioned between the non-slip sheets (21) and configured to extrude the non-slip sheets (21) to stretch outwards and cling to the inner wall of the outer pipe (30).

2. The telescoping pipe fitting of claim 1, wherein the non-slip sheet (21) is a circular sheet.

3. The telescoping pipe fitting of claim 2, wherein the non-slip sheet (21) is jointed to the outside of the inner pipe (20).

4. The telescoping pipe fitting of claim 1, wherein the inner pipe (20) has an outer wall provided with locating holes (200) for locating and installing the non-slip sheets (21), and non-slip sheets (21) have side walls toward the inner pipe (20) that are provided with protrusions (210) that can be embedded into the locating holes (200).

5. The telescoping pipe fitting of claim 1, wherein the elastic member (40) is an elastic ring with a notch.

6. The telescoping pipe fitting of claim 5, wherein the inner pipe (20) has one end that is provided with two non-slip sheets (21), and the two non-slip sheets (21) of the inner walls are provided with recesses (211) for placing the elastic member (40).

7. The telescoping pipe fitting of claim 1, wherein the elastic member (40) is a compression spring with a first end and second end that are respectively butted with inner walls of the two non-slip sheets (21).

8. The telescoping pipe fitting of claim 2, wherein the elastic member (40) is an elastic ring with a notch.

9. The telescoping pipe fitting of claim 3, wherein the elastic member (40) is an elastic ring with a notch.

10. The telescoping pipe fitting of claim 4, wherein the elastic member (40) is an elastic ring with a notch.
